(19) United States
(12) Patent Application Publication
(10) Pub. No.: US 2002/0111887 A1
(43) Pub. Date: Aug. 15, 2002

(54) Employee online activity monitoring system

(76) Inventors: Richard McFarlane, Redmond, WA (US); Howard Ringoen, Redmond, WA (US)

Correspondence Address: NIXON & VANDERHYE P.C., 8th Floor, 1100 North Glebe Road, Arlington, VA, 22201, US

(21) Appl. No.: 09/986,127

(22) Filed: Nov. 7, 2001

Related U.S. Application Data
(60) Provisional application No. 60/246,070, filed on Nov. 7, 2000.

(51) Int. Cl. G06F 17/60; G06F 7/00; G06F 17/00; G06F 15/173

(52) U.S. Cl. 705/30; 709/224; 707/104.1

(57) ABSTRACT

A method of monitoring employee online activity, including: importing firewall log files to a database to generate master activity files, wherein the master activity files includes data on Internet usage, e-mail usage and dial-in connections; importing current employee and company organizational structure information to the database; using the master activity files and the current employee and organizational structure information to produce summary reports on employee on-line activity; and providing the electronic summary reports to employees in response to a request for the information from the employee, wherein the summary reports include information on the employee as well as all other employees under the employee in the company organizational structure.

### FIELD OF THE INVENTION

The present invention relates to an on-line monitoring system for monitoring the online activity of employees within a company. More particularly, the invention provides an employee monitoring system that provides convenient and detailed reporting on the online activity of employees, such as employee Internet, e-mail (in/out) and dial-in activity, in a manner that corresponds to the particular organizational structure of the company.

### BACKGROUND AND SUMMARY OF THE INVENTION

It is now common for employees of a company to have desktop or convenient electronic access to many outside resources and communications channels, such as the Internet (including the World Wide Web) and e-mail (sending and receiving). In fact, many employees in today's business environment require access to such external resources in order to effectively perform their job. Thus, companies have provided employees with the necessary equipment, connections and software to enable employees to access these external resources from the company's office facility.

Additionally, when employees are not at the company facility, they may require or desire to access the company electronic resources through a dial-in connection or the like. Thus, many companies have also provided employees with the ability to dial-in to the company computer system from home or other external location, such as through the use of a home or portable computer, to access the company's internal computer system and associated resources.

Such internal access to outside resources and outside access to internal resources has provided a significant benefit to the overall ability for employees to perform their job, and in considered by many to be necessary tools in today's business environment. In fact, companies can and have benefited significantly from their employees proper use of the Internet, e-mail and dial-in connections for conducting company business.

However, the Internet and e-mail have also become widely popular and commonly used by people for personal reasons, such as online surfing, shopping, and communicating with friends and family, just to name a few. In addition, dial-in connections can raise security concerns, in that they provide the ability for employees to gain access to proprietary company information and resources from remote locations. Thus, there is potential for these resources to be abused or misused by employees or other unauthorized individuals (such as “hackers”).

Many companies now have computer resource usage guidelines and policies that must be followed by employees. Such guidelines or policies include, for example, the type of Internet usage that is permitted by employees, i.e. what types of web sites can and cannot be visited by an employee using a company computer. These policies may also include limitations on the amount of personal e-mails that may be sent or received by an employee using the company computer and e-mail account. The policies are designed not only to assure that employees are not spending too much company time on personal matters, but they are also designed to prevent available computer resources from being consumed by non-company or personal online activity. In other words, large amounts of personal Internet access or e-mail activity can significantly slow down or even prevent other important company business from being conducted using these same company resources.

For the reasons explained above, companies have in the past monitored the usage of employees with respect to Internet, e-mail and dial-in resources. Specifically, companies have generated and maintained log files that provide detailed information on employee usage of these resources. For example, log files have been kept that provide, on an employee by employee basis, information on the amount of Internet access and the specific Internet sites visited by employees, as well as the incoming and outgoing e-mail activity of employees. It is noted that companies are generally not concerned with company internal e-mail activity, but only e-mails coming from and going to external locations. Companies have also monitored dial-in activity of employees in order to provide the ability to check for any unusual activity that may indicate that an employee or some unauthorized individual is accessing or downloading proprietary company information or is engaging in some other unauthorized dial-in activity. Most companies base these logs on activity which passes through what is generally referred to as the company “firewall”, which controls and/or allows information to pass to the company computer system to external locations and visa versa.

By maintaining these log files, a company can review the log files to assure that company policies are being followed, as well as to look for indications of security violations. The log files can also be reviewed if resource availability or slow down problems occur, in order to attempt to determine the reason for the problem.

One problem that has arisen in connection with the monitoring of such firewall log files is that it takes significant time and effort to review the log files, and/or to convert the log files to reports that can be used by the company in an efficient and effective manner. Moreover, there has been no mechanism for easily and efficiently making the appropriate log file information available to the appropriate people within the organization and/or to provide the log file information in a manner that corresponds to the company organizational structure. Further, there is a need to automatically highlight information contained in the log chart that indicates unusual high activity, in order to make reviewing of the log information easier and more efficient, as well to assure that important information is not missed by the person reviewing the information.

The instant invention solves these problems by providing an automated employee online activity monitoring system that summarizes the firewall log file information in a way that corresponds to the organizational structure or chart of the company, as well as automatically highlights information that may indicate employee abuse. More particularly, the invention summarizes utilization of company resources by employee in a manner that enables managers to easily and efficiently review the usage information for all employees over which they have particular responsibility. The invention summarizes firewall logs for all Internet browsing and calculates the bytes transferred at the employee's request, as well as calculates an estimated number of page views. The invention also gathers together Internet e-mail logs and summarizes, by employee, messages, attachments and bytes sent and received, as well as e-mail destination and origin information. The invention further summarizes, by employee, the dial-in connections by connections (e.g. caller id), duration, and bytes transferred.

In accordance with the invention, the summary information is then made available to employees based on the organizational structure of the company. In other words, when log information is requested, a summary table is provided that not only shows summary usage information for the particular person requesting the information, but also for all employees (if any) that the requester has particular responsibility for based on the organizational structure of the company. Thus, a manager will see his usage activity, as well as the usage activity of all persons under his management authority, as defined by the organizational chart of the company. In accordance with another aspect of the invention, the information includes highlights, such as a color coding scheme, that highlights information in the report that represents relatively large amounts of usage activity, thereby facilitating easy recognition by a manager of unusually high usage activity. The color coding scheme may, for example, highlight the top 10% with one color, such as red, and the top 20% with a different color, such as yellow.

### BRIEF DESCRIPTION OF THE DRAWINGS

These and other objects, features and advantages of the instant invention will become apparent from a review of the following detailed description of the invention when read in conjunction with the following figures, in which:

FIG. 1 is a schematic view of the overall computer system environment in which the invention is designed to operate;

FIG. 2 is a block diagram of the main steps used to produce the log file summaries in accordance with the instant invention;

FIG. 3 is a block diagram of the main steps that occur when a request for summary information is received by the system, in accordance with the instant invention;

FIG. 4 is a diagram illustrating the flow of data from the daily log files to master log files;

FIG. 5 is a diagram illustrating the flow of data from the master log files to the summary files;

FIG. 6 provides a sample company organizational chart as used in accordance with the instant invention; and

FIG. 7 shows sample files and data fields that can be used to produce the log files and summaries in accordance with the instant invention.

### DETAILED DESCRIPTION OF THE PREFERRED EMBODIMENTS

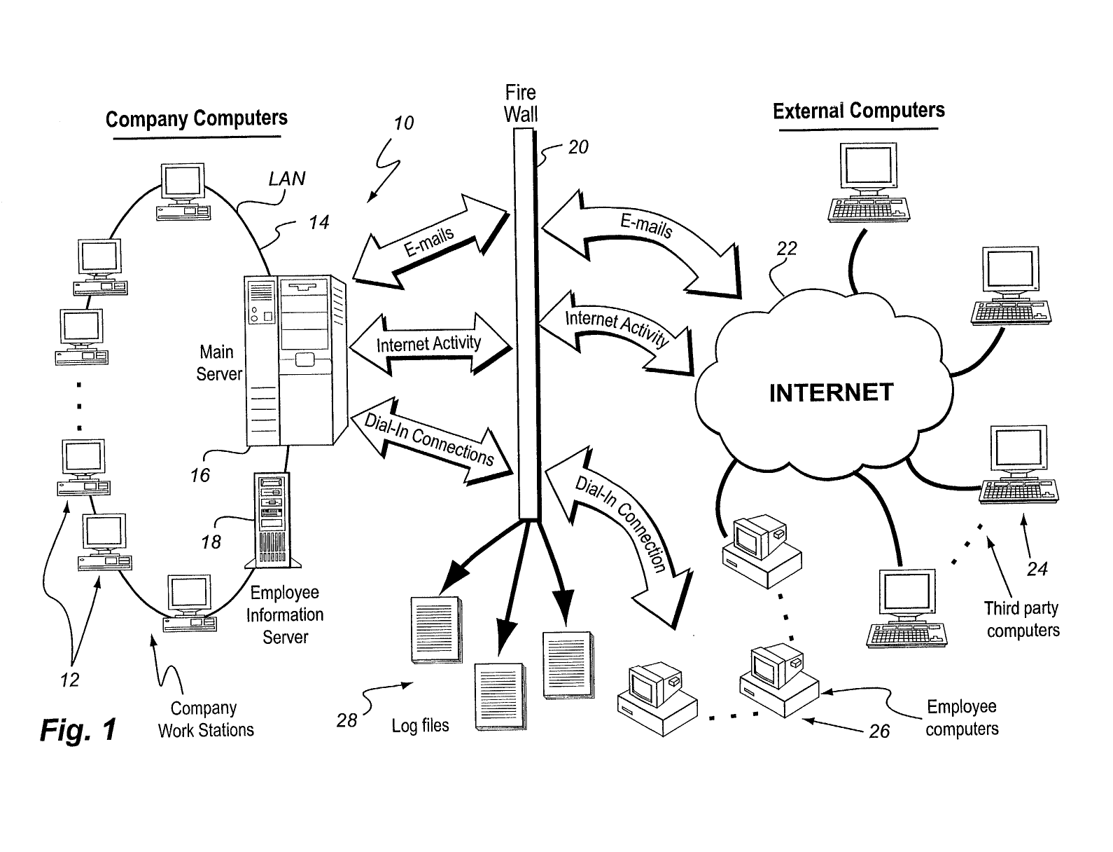

FIG. 1 shows, in a simplified form, a typical computing environment in which the instant employee online activity monitoring system is designed to operate. Specifically, the company computer system 10, as shown on the left side of FIG. 1, includes numerous computer workstations 12 connected via a local area network (LAN) 14 to one or more company computers systems 16 and 18. One or more of these servers is typically used to handle and control access by the company computers to resources that are outside of the company through a firewall 20. These external communications may take the form of e-mails, Internet browser activity and/or dial-in connections. Thus, the external communications may access the Internet 20 or send or receive e-mail communications from non-company or third party computers 24 connected to the Internet (or via other communications channel(s)). In addition, the company computer system 10 may be accessed by employees using dial-in connections, via modems and telephone lines, and through the use of home or portable computers 26 available to the employees when not at work.

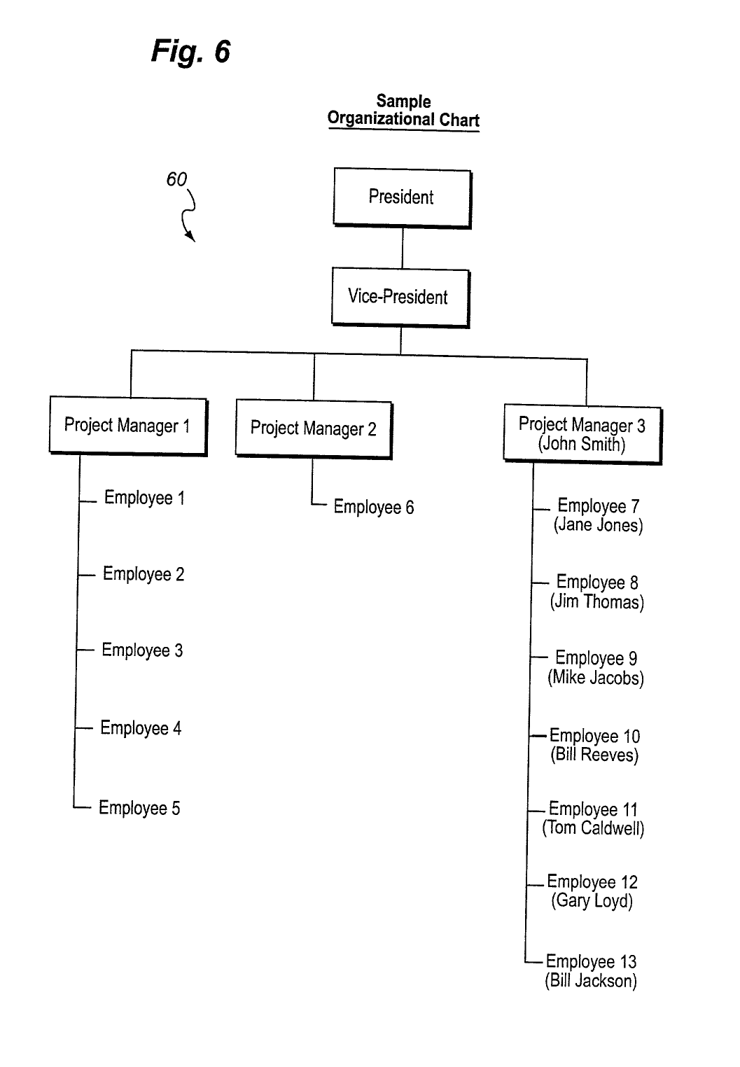

Information on employees of the company may also be provided by one of the servers, such as server 18 in this example, which may be an IBM AS/400 server. This employee information server operates as an employee management system (EMS), and maintains updated information on current employees and information on how the employees are positioned within the company's organizational structure. This organizational structure or chart 60 is typically are hierarchical structure, such as that shown by the simple example in FIG. 6, wherein the chart 60 shows the various levels of management within the company, as well as who is directly and ultimately responsible for each employee of the company. It is noted that FIG. 6 shows an organization chart for a small company and that many companies for which the instant invention could be used would have much more complicated and detailed organization charts. It is also noted that, for simplicity, the exemplary chart 60 of FIG. 6 only lists the title of the persons on the chart, except for the right hand branch which uses actual employee names. However, a typical organizational chart will include the title and name of every employee in the chart. The lower right hand portion of the chart includes actual names in order to correspond to the example embodiment of the invention provided and discussed in detail below.

As shown in FIG. 1, log files 28 are generated which provide detailed information on all activity passing through the firewall 20. In other words, the log files 28 contain information showing Internet, e-mail (sent and received) and dial-in activity for all persons having authorized access to the company computers, as well as possibly on unauthorized attempts to access the company computer system 10.

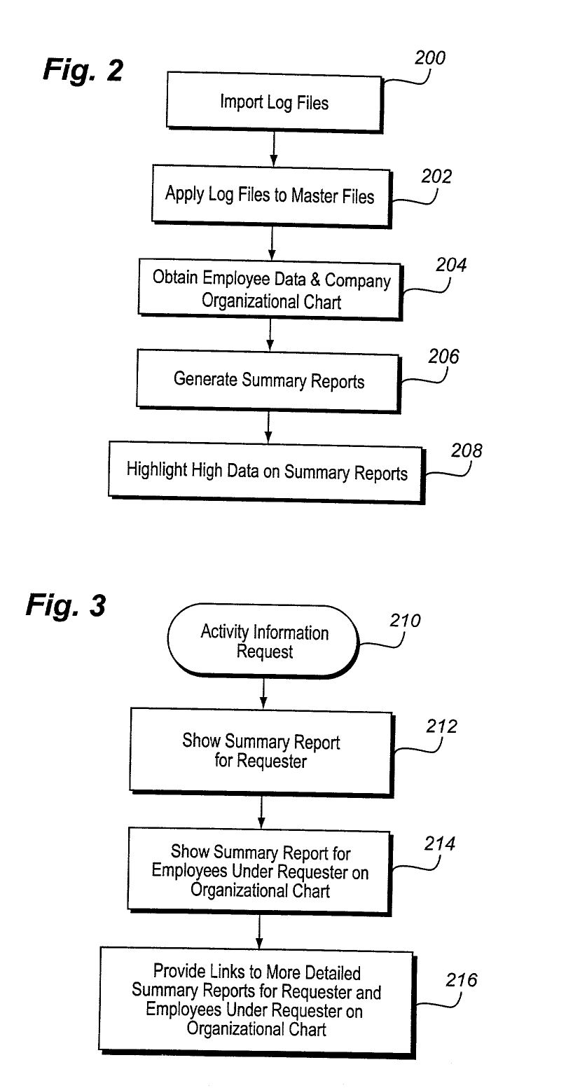

FIG. 2 shows, in a general manner, the steps that are taken by an application program, in accordance with the instant invention, to provide summaries of the data from the firewall log files 28. Specifically, in a first step 200, the log files 28 are imported and loaded into a database, such as an Oracle database. This importation is used to apply the log file data (preferably on a daily basis) to the master database files that contain the log information for a defined period of time, such as 90 days (step 202). The current employee and company organizational structure information is then obtained from the employee management system (EMS) provided by the employee information server 18 (step 204). The application then queries the database to obtain the information from the master files to create summary reports (step 206) for all of the current employees based on the employee and organization structure information. The summary reports are preferably prepared on a daily basis after the daily log files are added to the master files. The application program then identifies the information in the report that indicates relatively high usage activity and encodes this information in a manner that will cause the information to stand out when the information is reviewed on a computer screen or the like. For example, the application may cause the top 10% usage activity information to be shown with a red background and the top 20% usage activity information to be shown with a yellow background, thereby making this information stand out when the information is reviewed. While color coding is preferred, any other suitable encoding can be done to the data that will cause it to stand out to the viewer (such as increased size, character blinking or the like).

Once the summary reports are created, the reports are then available to the company personnel, preferably by clicking on an icon provided on the desktop of each company workstation. FIG. 3 shows the general steps that are taken when a request is made for the summary information by an employee. When an employee makes a request for the information (action 210), the application program shows the summary information previously generated for the requester to the requester (step 212). In addition to showing the requester's usage summary information, the requester is also shown summary information for each employee that is under the requester on the organizational chart of the company (step 214). For example, when a manager requests summary information (e.g. by clicking on the application icon) the manager sees a table showing his summary usage information and the summary information for all employees under his management. The summary report preferably includes links to more detailed summary information (step 216), so that the requester can click on information to see more detailed information relating to this information. For example, if the summary chart shows high Internet usage (which may be color coded red, for example), the usage information may be clicked on to see information on what Internet sites the employee has visited, so that a determination can be made as to whether the company policy regarding Internet usage is being adhered to by the employee. Similarly, if large e-mail usage is indicated by the summary report, the information can be clicked on to see the addresses to which the e-mails have been sent to and/or received from. This linking functionality, as well as the details provided by the reports will be described in more detail in connection with the example discussed below.

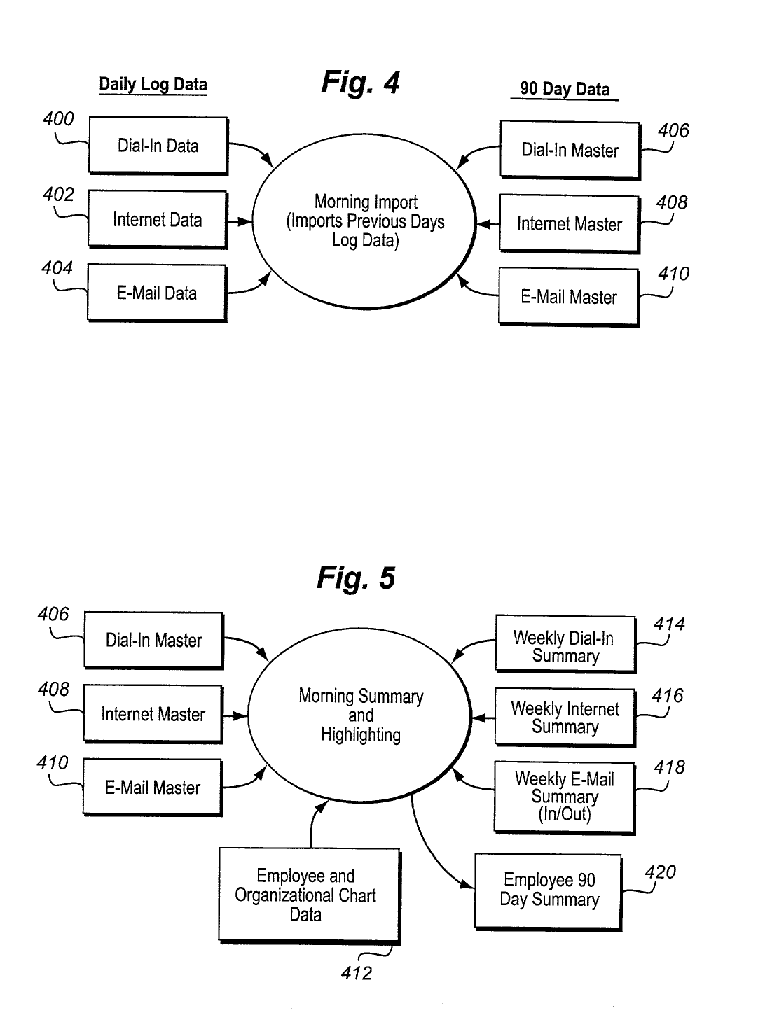

FIG. 4 shows a general diagram of the data used and the flow thereof in connection with the building of the master files. Specifically, the daily firewall log files are imported each morning into the database. These daily log files 28 include dial-in log data 400, Internet log data 402 and e-mail log data 404. The application program imports the daily log files into the database tables that provide, for example, a 90 day activity table (master files 406, 408, 410) for each of the log types (i.e., dial-in, Internet, e-mail). Preferably, the e-mail is broken down into incoming and outgoing e-mails at this time, so that the master files actually include four main tables.

FIG. 5 shows a general diagram of the data use and flow thereof in connection with building the summary reports. Specifically, the application uses the master files (406-410), as well as the employee and organizational chart information, to produce summary reports that can be viewed in response to a request from company personnel. The employee and organizational chart information is first also loaded for this purpose into the database from the EMS system which is typically maintained by the human resources department of the company. In other words, this employee and organizational information is preferably also imported into the database on a daily basis so that accurate information is used when building the summary reports. The application program preferably generates a weekly dial-in summary 414, a weekly Internet summary 416, weekly e-mail (in and out) summary 418 and a rolling employee 90-day summary 420 for each log type. All of these reports are then available to company personnel in response to a request for the information.

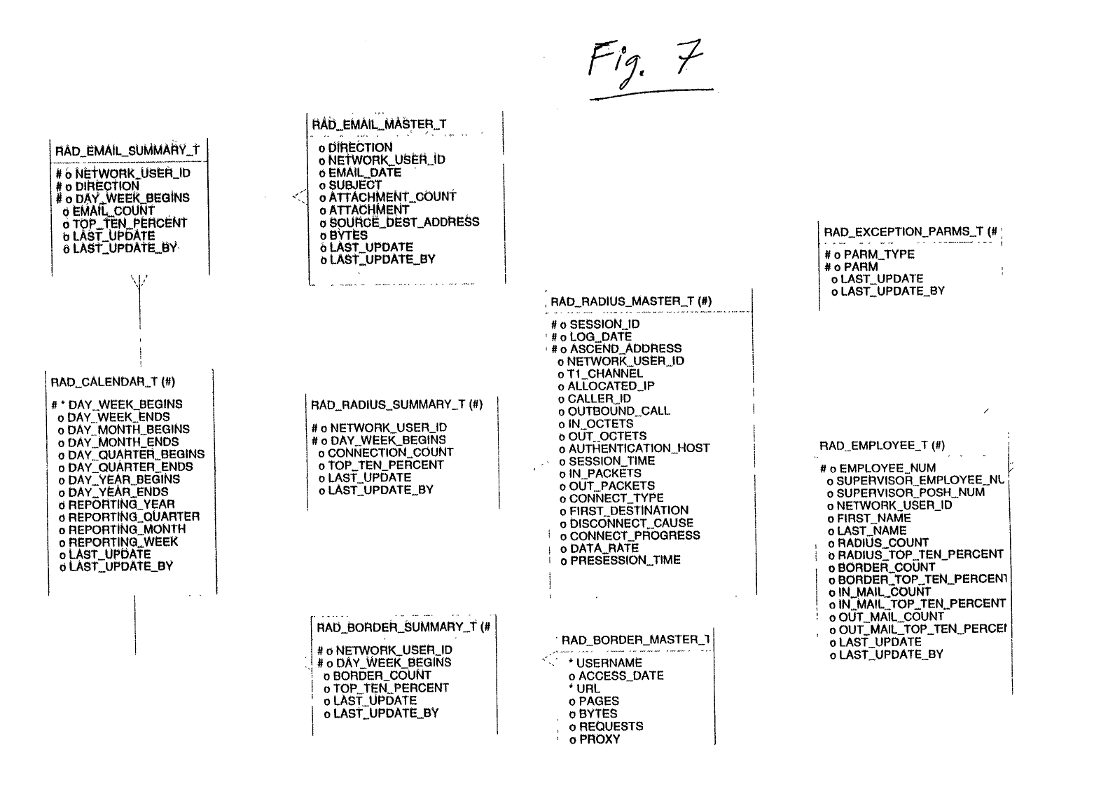

FIG. 7 shows exemplary types of files and data fields that may be collected and used in order to implement the instant invention.

An example of the instant invention will now be described. This example is based on the sample organizational chart 60 of FIG. 6. As noted previously, this chart represents a simply organizational structure and most companies that could benefit from use of the instant invention will have a much larger and more complicated organizational chart. This chart shows a four level hierarchy—President, Vice President, Project Managers and regular employees. Actual names are only used in connection with the right hand project manager and employee levels so as to correspond to the example tables provided below. It is assumed by the application of the instant invention that people on the chart have at least some level or responsibility for every person below that person on the chart. As can be seen from this organizational chart 60, the President is ultimately responsible for all other company personnel, including the Vice President, all project managers and all employees. The Vice President is responsible for the Project Managers and the employees. Project manager 1 is responsible for employees 1-5, Project Manager 2 is responsible for employee 6, and Project Manager 3 is responsible for employees 7-13. Thus, the organizational chart provides a mapping of who within the organization is responsible for who. This information is used to determine what usage activity summary information will be provided to a person when the information is requested by that person. In other words, the usage information is provided in a customized manner for each person within the organization, so that each person sees the information for himself as well as all other people who they are responsible for, based on the organizational chart. This greatly simplifies the process of reviewing the log information as compared to the prior art, because it enables only the relevant information to be provided to each person. In other words, there is no need to show the information on employee 6 to Project Manager 1, due to the fact that this manager has no responsibility for employee 6.

The following table (Table 1) shows an exemplary rolling 90-day summary for John Smith, Project Manager 3 in the example of FIG. 6.

TABLE 1
Rolling 90 Day Activity for John Smith

| Employee | Dial-In/Out | Browser | | Out Email |
|---|---|---|---|---|
| Name | Count | Requests | In Email Count | Count |
| John Smith | 53 (Red) | 29746 | 324 | 90 |
| Jane Jones | 0 | 2268 | 11 | 2 |
| Jim Thomas | 0 | 30984 | 61 | 25 |
| Mike Jacobs | 9 | 10495 | 187 | 75 |
| Bill Reeves | 0 | 15769 | 20 | 6 |
| Tom Caldwell | 0 | 10975 | 462 (yellow) | 60 |
| Gary Loyd | 0 | 6064 | 145 | 46 |
| Dave Brown | 0 | 9271 | 70 | 44 |

As can bee seen in Table 1, when John Smith requests summary information, such as by clicking on an icon which opens the application described herein, Table 1 is shown on John Smith's computer screen. Due to the fact that the organizational chart indicates that John Smith has responsibility over seven employees, each of these employees are also included in the summary chart. Thus, John Smith is provided with a summary chart including usage information on himself and his seven employees (listed by name in Table 1).

In Table 1, the Dial-In/Dial-Out Count represents the number of times the employee dialed into the company computer using remote dial-in/out services. Thus, during the last 90-day period, the summary report indicates that John Smith dialed in 53 times, Mike Jacobs dialed in 9 time and the remaining employees on the chart did not dial in at all. The Browser Requests in Table 1 indicate the number of times the employee retrieved an “element” of information from the Internet. It is noted that pages or screens retrieve between 5-10 elements each, but web sites may vary significantly with respect to the number elements retrieved, due to the ad serving and other activity which results when a site is visited. The In Email Count represents the number of Internet inbound e-mails to the employees company e-mail account, such as a Group Wise account. The Out Email Count represents the number of Internet outbound e-mails from the employee's e-mail account. Time stamps are preferably used and indicate when the mail leaves the company server and may vary from the time the mail was sent from the workstation. It is noted that internal e-mails are preferably not tracked by this embodiment of the system, because only the firewall (i.e. Internet) e-mails are counted.

In accordance with the invention, the information in the table which falls within the top 10% for the entire company are highlighted in red and the top 20% are highlighted in yellow. Thus, John Smith's 53 Dial-In/Out Count is colored red and Tom Caldwell's 462 In Email Count is highlighted in yellow. The count value represents the number of dials. This highlighting makes possibly important or unusual information more readily noticed by the viewer. The table also includes links to more detailed information, as indicated by the underlining of information. Thus, by clicking on the underlined information more detailed information relating to that information can be seen.

The following table (Table 2) shows the result of clicking on John Smith's Dial-In/Out Count.

TABLE 2
Dial-In/Out Counts by Week for John Smith

| Week Beginning | Dial-In/Out Count |
|---|---|
| 07-Aug-2000 | 4 |
| 14-Aug-2000 | 1 |
| 21-Aug-2000 | 2 |
| 28-Aug-2000 | 3 |
| 04-Sep-2000 | 4 |
| 11-Sep-2000 | 1 |
| 18-Sep-2000 | 3 |
| 25-Sep-2000 | 2 |
| 02-Oct-2000 | 15 (red) |
| 09-Oct-2000 | 5 |
| 16-Oct-2000 | 7 (yellow) |
| 23-Oct-2000 | 4 |
| 30-Oct-2000 | 2 |

Table 2 provides a more detailed view of John Smith's Dial-In/Out Count. Specifically, this table shows his dial-in activity by week for a 90-day period. The color coding scheme described above is again used on this table to highlight high usage activity. Also, as explained above, the information includes links to more detailed information, as indicated in the following table (Table 3).

TABLE 3
Dial-In/Out Details for John Smith
for the Week Beginning 02-Oct-2000

| | | | | | Session |
|---|---|---|---|---|---|
| | | Outbound | | | Time |
| Log Date | Caller ID | Call | In Bytes | Out Bytes | (hh:mm:ss) |
| 02-Oct-00 | 4258214956 | | 38,714 | 31,335 | 0:13:49 |
| 00:17:52 | | | | | |
| 02-Oct-00 | 8479283888 | | 288,177 | 1,221,635 | 0:38:35 |
| 19:38:34 | | | | | |
| 03-Oct-00 | 8479583888 | | 499,209 | 1,618,136 | 1:25:19 |
| 16:43:04 | | | | | |
| 04-Oct-00 | 8476716350 | | 4,479 | 2,628 | 0:00:22 |
| 15:47:08 | | | | | |
| 04-Oct-00 | 8479283888 | | 366,329 | 1,360,310 | 0:52:15 |
| 16:45:14 | | | | | |
| 04-Oct-00 | 8479283888 | | 4,664 | 2,620 | 0:00:35 |
| 19:41:14 | | | | | |
| 04-Oct-00 | 8479283888 | | 4,755 | 2,753 | 0:01:07 |
| 19:43:42 | | | | | |
| 04-Oct-00 | 8479283888 | | 40,084 | 105,595 | 0.08.16 |
| 19:57:26 | | | | | |
| 05-Oct-00 | 8479283888 | | 114,772 | 271,769 | 0:17:24 |
| 09:59:23 | | | | | |
| 05-Oct-00 | 8159420953 | | 4,426 | 2,628 | 0:00:28 |
| 20:43:42 | | | | | |
| 05-Oct-00 | 8159420953 | | 416,079 | 1,203,659 | 1:20:50 |
| 22:06:06 | | | | | |
| 06-Oct-00 | 8159420953 | | 78,681 | 195,782 | 0:25:11 |
| 16:32:27 | | | | | |
| 06-Oct-00 | 8159420953 | | 299,301 | 1,431,559 | 0:50:24 |
| 21:20:42 | | | | | |
| 08-Oct-00 | 8159420953 | | 353,030 | 1,350,676 | 0:30:27 |
| 06:39:49 | | | | | |
| 08-Oct-00 | 4258214956 | | 95,444 | 1,580,267 | 0:56:01 |

Table 3 shows John Smith's detailed dial-in activity by week. The Log date represents the date and time the employee dialed the company. The Caller Id represents the inbound number where the call originates. The Outbound Call is the number called. The In Bytes column indicates the number of characters transferred to the company. The Out Bytes column indicates the number of characters transferred from the company. Finally, the Sessions Time indicates the amount of time the dial connection was connected. In this example, there is no more detailed information on dial-in/out activity, due to the fact that no information on this table is underlined. Thus, if further information is desired for some reason, the original log files can be reviewed outside of this application.

The following table (Table 4) is shown in response to clicking on John Smith's Browser Requests entry shown in Table 1.

TABLE 4
Browser Counts by Week for John Smith

| Week Beginning | Browser Requests |
|---|---|
| 07-Aug-2000 | 1425 |
| 14-Aug-2000 | 1423 |
| 21-Aug-2000 | 2202 |
| 28-Aug-2000 | 3389 |
| 04-Sep-2000 | 476 |
| 11-Sep-2000 | 2004 |
| 18-Sep-2000 | 1141 |
| 25-Sep-2000 | 2591 |
| 02-Oct-2000 | 1806 |
| 09-Oct-2000 | 3298 |
| 16-Oct-2000 | 4113 (yellow) |
| 23-Oct-2000 | 4149 (yellow) |
| 30-Oct-2000 | 1729 |

Table 4 shows the Internet browser activity by week for John Smith. Again, the color coding scheme is used to highlight any top 10% (red) or 20% (yellow) information based on the information for the entire company. In this example, there are two yellow entries indicating that during the weeks of Oct. 16 and 23, 2000, John Smith's activity fell within the top 20 percent for the entire company. The following table (Table 5) shows the result of clicking on the Oct. 16, 2000 entry.

TABLE 5
Browser Details for John Smith for the Week Beginning 16-Oct-2000

| Access Date | URL | Bytes | Requests |
|---|---|---|---|
| 16-Oct-00 13:40:18 | www.nintendo.com | 46,872 | 29 |
| 16-Oct-00 13:42:01 | cbs.sportsline.com | 373,342 | 72 |
| 16-Oct-00 13:46:16 | espn.go.com | 547,807 | 77 |
| 16-Oct-00 15:05:20 | www.nintendo.com | 319,199 | 111 |
| 16-Oct-00 15:10:49 | www.dominopower.com | 280,581 | 44 |
| 16-Oct-00 15:17:13 | www.groupcomputing.com | 282,879 | 139 |
| 16-Oct-00 15:26:06 | www.as400.ibm.com | 88,381 | 58 |
| 16-Oct-00 17:09:44 | www.wsdot.wa.gov | 115,777 | 18 |
| 16-Oct-00 17:10:23 | cbs.sportsline.com | 26,091 | 15 |
| 17-Oct-00 08:24:48 | www.nintendo.com | 348 | 13 |
| 17-Oct-00 10:50:44 | www.advisor.com | 235,440 | 133 |
| 17-Oct-00 12:42:19 | inbox.excite.com | 120,805 | 39 |
| 17-Oct-00 12:43:15 | my.aol.com | 86,514 | 43 |
| 17-Oct-00 12:45:42 | cbs.sportsline.com | 184,954 | 79 |
| 17-Oct-00 15:51:26 | www.nintendo.com | 493 | 18 |
| 17-Oct-00 17:17:21 | www.wsdot.wa.gov | 145,545 | 23 |
| | • | | |
| | • | | |
| | • | | |

Table 5 shows the Internet browser activity for John Smith for the week selected. The Access Date indicates the date visited. The URL column indicates the site visited. The Bytes column indicates the number of characters transferred from the web site visited. The Requests column indicates the number of times the employee retrieved an element of information from the Internet. In is noted that pages or screens retrieve between 5 and 10 elements each, while sited vary widely. The information in Table 5 can be used, for example, to determine if the employee is following the company policy with respect to Internet usage.

Table 6 shows the resulting information that is shown when the In Email Count information for John Smith is clicked on in table 1 above.

TABLE 6
In Mail Counts by Week for John Smith

| Week Beginning | Mail Count |
|---|---|
| 07-Aug-2000 | 23 |
| 14-Aug-2000 | 19 |
| 21-Aug-2000 | 24 |
| 28-Aug-2000 | 26 |
| 04-Sep-2000 | 24 |
| 11-Sep-2000 | 31 |
| 18-Sep-2000 | 21 |
| 25-Sep-2000 | 19 |
| 02-Oct-2000 | 30 |
| 09-Oct-2000 | 18 |
| 16-Oct-2000 | 33 |
| 23-Oct-2000 | 25 |
| 30-Oct-2000 | 31 (yellow) |

Table 6 shows the incoming e-mail activity by week for a 90-day period. Again, the color coding is used as described above to indicate relatively high activity. Thus, the October 30 information is yellow, thereby indicating that the usage for that week is in the top 20% for the entire company. The following table (Table 7) shows the result of clicking on the Aug. 7, 2000 information.

TABLE 7
In Email Details for John Smith for the Week Beginning 07-Aug-2000

| Email | Attach- | | |
|---|---|---|---|
| Date/Time | ment | | |
| (PST*) | Count | Address | Bytes |
| 07-Aug-2000 | 1 | 86D6CE90@MessageREACH.com | 38,714 |
| 09:24:25 | | | |
| 07-Aug-2000 | 1 | 07D7C12D@MessageREACH.com | 4,779 |
| 16:04:04 | | | |
| 07-Aug-2000 | 1 | jsnews@EARTHWEB.COM | 26,497 |
| 18:14:20 | | | |
| 07-Aug-2000 | 1 | 00805FA7CAE6_US@Newsletter | 3,467 |
| 18:32:09 | | | |
| 07-Aug-2000 | 1 | MichaelWetherbee@teamstudio.com | 17,946 |
| 20:44:22 | | | |
| 08-Aug-2000 | 1 | 5CD0788E@MessageREACH.com | 42,819 |
| 15:27:28 | | | |
| 08-Aug-2000 | 1 | AdvisorTips@advisor.com | 12,240 |
| 22:01:44 | | | |
| 09-Aug-2000 | 1 | synchrologic@processrequest.com | 1,237 |
| 00:54:54 | | | |
| 09-Aug-2000 | 1 | THEVIEW@eVIEW.com | 16,984 |
| 14:29:14 | | | |
| 09-Aug-2000 | 1 | CC871A84@MessageREACH.com | 28,419 |
| 16:20:48 | | | |
| 09-Aug-2000 | 1 | customerservice@gantthead.com | 60,041 |
| 16:26:52 | | | |
| | | • | |
| | | • | |
| | | • | |

Table 7 shows the incoming e-mail activity for John Smith for the week beginning Aug. 7, 2000. This table shows the date and time of the e-mail, the number of attachments, the address from the e-mail was sent, and the number of bytes transferred. It is noted that this table is truncated for convenience and does not include all of the counts indicated in Table 6.

The following table (Table 8) shows the result of clicking on the Out Email Count entry for John Smith in Table 1.

TABLE 8
Out Mail Counts by Week for John Smith

| Week Beginning | Mail Count |
|---|---|
| 07-Aug-2000 | 1 |
| 14-Aug-2000 | 2 |
| 21-Aug-2000 | 10 |
| 28-Aug-2000 | 4 |
| 11-Sep-2000 | 17 |
| 18-Sep-2000 | 6 |
| 25-Sep-2000 | 2 |
| 02-Oct-2000 | 4 |
| 09-Oct-2000 | 2 |
| 16-Oct-2000 | 13 |
| 23-Oct-2000 | 12 |
| 30-Oct-2000 | 17 |

Table 8 indicates the outgoing e-mails for John Smith by week for the past 90-day period. It is noted that none of these entries represent a top 10% or top 20% usage, due to the fact that no colored entries are present. The following table (Table 9) shows the result of clicking on the Aug. 7, 2000, entry for John Smith in Table 8.

TABLE 9
Our Email Details for John Smith for the Week Beginning 07-Aug-2000

| Email | Attachment | | |
|---|---|---|---|
| Date/Time(PST*) | Count | Address | Bytes |
| 07-Aug-00 | 2 | Wetherbee@teamstudio.com | 3,530 |
| 20:49:48 | | | |

Table 9 shows details of the one count indicated for the week August 7 indicated in Table 8. This table shows the date, attachment count, address to which the e-mail was sent and the number of bytes transferred.

This completes the example described by Tables 1-9 above. However, it is noted that the particular information and amount thereof will vary depending on who requests the information and the position that that person occupies in the company's organizational structure. For example, referring back to FIG. 6 if the information is requested by the Vice President, he will see entries like the tables above except that they will cover all of the people under him on the organizational chart. In contrast, if employee 6 requests the information, he will only see the information for himself, due to the fact that nobody is below him on the organizational chart. The same is true for each of employees 1-13, as these employees are all at the bottom level of the chart. Project Manager 1, however, will see his information and employee 6's information, while the president will see information for everybody in the company.

As can be seen from the description of the invention and the example above, the instant invention can be easily and effectively used to monitor employee usage of Internet, e-mail and dial-in connections. The invention provides employee usage activity information in a convenient, hierarchical and highlighted manner that facilitates quick and accurate review of the information for the purpose of identifying any improper or excessive use of these resources.

While the invention has been described with respect to its preferred implementation and embodiment, various changes and modification may be made thereto, as one skilled in the art will readily understand from the description of the invention herein. Thus, the invention is not intended to be limited by the specific exemplary embodiment described herein.

What is claimed is:

1. A method of monitoring employee online activity, comprising:
a) importing firewall log files to a database to generate master activity files, wherein the master activity files includes data on Internet usage, e-mail usage and dial-in connections;
b) importing current employee and company organizational structure information to the database;
c) using the master activity files and the current employee and organizational structure information to produce electronic summary reports on employee on-line activity; and
d) providing the electronic summary reports to employees in response to a request for the information from the employee, wherein the summary reports include information on the employee as well as all other employees under the employee in the company organizational structure;

2. The method of claim 1, further including highlighting information in the electronic summary reports that indicate high usage activity relative to usage information for all other employees of the company.

3. The method of claim 1, further including providing links in the summary reports which, upon selection, provide further detailed summary information relating to the information selected.

4. The method of claim 2, further including providing predetermined rolling time period for the summary reports.

5. The method of claim 3, further including providing dial-in/dial-out, browser request, in e-mail count and out e-mail counts for each of the employees listed in the summary report.

6. The method of claim 5, further including providing electronic links in the summary report that enables further details on the counts listed in the report to be displayed.

7. The method of claim 5, further including providing count information on dial-in/dial out activity for an employee by week in response to selection of a link in the summary report.

8. The method of claim 7, further including providing a further link in the weekly activity report that indicates a telephone number called and an amount of data transferred.

9. The method of claim 5, further including providing a weekly browser activity report in response to selection of a link in the summary report.

10. The method of claim 9, further including providing information on URL and amount of information transferred in response to selection of a link in the weekly browser activity report.

11. The method of claim 5, further including providing a e-mail count weekly report in response to selection of a link in the summary report.

12. The method of claim 11, further including providing information on the number of attachments, addresses and amount of information transferred in response to a link in the e-mail count weekly report.
